(19) United States
(12) Patent Application Publication
(10) Pub. No.: US 2026/0269105 A1
(43) Pub. Date: Sep. 10, 2026

(54) WIRE HARNESS ASSEMBLY SYSTEMS AND METHODS

(71) Applicant: The Boeing Company, Arlington, VA (US)

(72) Inventors: Adrienne C. Engholm, Everett, WA (US); Tyler D. Wortham, Stanwood, WA (US); Kevin M. Barrick, Kingston, WA (US)

(73) Assignee: The Boeing Company, Arlington, VA (US)

(21) Appl. No.: 19/070,827

(22) Filed: Mar. 5, 2025

(51) Int. Cl. H01B 13/012

(52) U.S. Cl. CPC H01B 13/01245

(57) ABSTRACT

A system for assembling a wire harness includes a formboard. The formboard includes a routing surface configured to support wires of the wire harness during assembly. The formboard includes a plurality of route path markers defining a plurality of wire route paths on the routing surface. The formboard includes a plurality of light-emitting indicators integrated at ends of the route path markers. Pairs of the light-emitting indicators identify opposing end locations of the wire route paths. The system includes a computer configured to activate the pairs of the light-emitting indicators corresponding to wire identifications of the wires such that an activated pair of the light-emitting indicators visually guide placement of opposing ends of the wires.

### FIELD

The present disclosure relates generally to production of electrical wire and cable harnesses and, more particularly, to systems and methods for assembling and producing wire and cable harnesses.

### BACKGROUND

Assembling electrical wire or cable harnesses is a difficult and labor-intensive process. Existing assembly systems require an operator to identify each wire, locate the identified wire in a wire specification data sheet or other tabulated list of wires, determine end locations of the wire from the data sheet, find the end locations and associated route path for the wire on an assembly tool, manually route the wire along the route path, and temporarily secure the ends of the wire at the end locations of the route path. This process must be repeated dozens of times with different wires having different end locations and route paths. Accordingly, those skilled in the art continue with research and development efforts in the field of wire and cable harness assembly.

### SUMMARY

Disclosed are examples of a system for fabricating a wire harness, a formboard for fabricating a wire harness, and a method for fabricating a wire harness. The following is a non-exhaustive list of examples, which may or may not be claimed, of the subject matter according to the present disclosure.

In an example, the disclosed system includes a formboard. The formboard includes a routing surface configured to support wires of a wire harness during assembly. The formboard includes a plurality of route path markers defining a plurality of wire route paths on the routing surface. The formboard includes a plurality of light-emitting indicators integrated at marker ends of the route path markers. Pairs of the light-emitting indicators identify opposing locations of path ends of the wire route paths. The system includes a computer configured to activate the pairs of the light-emitting indicators corresponding to wire identifications of the wires such that an activated pair of the light-emitting indicators visually guide placement of opposing wire ends of the wires.

In an example, the disclosed formboard includes a routing surface configured to support wires of a wire harness during assembly. The formboard includes a plurality of route path markers defining a plurality of wire route paths on the routing surface. The formboard includes a plurality of light-emitting indicators integrated at marker ends of the route path markers. Pairs of the light-emitting indicators are activated to identify opposing locations of path ends of the wire route paths.

In an example, the disclosed wire harness assembly includes a formboard and a wire harness routed on the formboard. The formboard includes a routing surface configured to support wires of the wire harness during assembly. The formboard includes a plurality of route path markers defining a plurality of wire route paths on the routing surface. The formboard includes a plurality of light-emitting indicators integrated at marker ends of the route path markers. Pairs of the light-emitting indicators are activated to identify opposing locations of path ends of the wire route paths.

In an example, the disclosed method includes steps of: (1) receiving a wire identification corresponding to a wire to be routed; (2) selectively activating a pair of light-emitting indicators on the formboard corresponding to the wire identification; and (3) placing the wire along a wire route path extending between the pair of light-emitting indicators.

Other examples of the system, the formboard, and the method will become apparent from the following detailed description, the accompanying drawings, and the appended claims.

### BRIEF DESCRIPTION OF THE DRAWINGS

FIG. 1 is a block diagram of an example of a system;

FIG. 2 is a flow diagram of an example of a method;

FIG. 3 is a schematic illustration of an example of the system;

FIG. 4 is a schematic illustration of an example of a wire routed along a route path of a formboard of the system;

FIG. 5 is a schematic illustration of an example of a wire harness assembled on the formboard of the system;

FIG. 6 is a schematic illustration of an example of a light assembly of the formboard;

FIG. 7 is a schematic illustration of examples of light-emitting indicators of the system integrated with the formboard;

FIG. 8 is a schematic, perspective view of an example of the light-emitting indicator depicted in FIG. 7;

FIG. 9 is a schematic, perspective view of an example of the light-emitting indicator;

FIG. 10 is a schematic, opposing perspective view of the example of the light-emitting indicator depicted in FIG. 9;

FIG. 11 is a schematic, perspective view of an example of a standoff fixture of the system;

FIG. 12 is a schematic illustration of an example of the standoff fixture depicted in FIG. 10 in use to secure the formboard;

FIG. 13 is a schematic, perspective view of an example of the standoff fixture;

FIG. 14 is a schematic, perspective view of an example of a scan assembly;

FIG. 15 is a schematic, perspective, partially exploded view of an example of the scan assembly depicted in FIG. 14;

FIG. 16 depicts an example of a graphical user interface;

FIG. 17 depicts an example of the graphical user interface;

FIG. 18 is a block diagram of an example of a data processing system;

FIG. 19 is a schematic illustration of an example of an aircraft; and

FIG. 20 is a flow diagram of an example of an aircraft manufacturing and service method.

### DETAILED DESCRIPTION

Generally, the following detailed description describes a light-enhanced assembly system for fabrication of electrical wire harnesses. The system is configured to automatically illuminate or otherwise visually indicate opposing (e.g., “from” and “to”) end locations of each wire of an electrical wire bundle that is routed on a formboard or other assembly tool during assembly of an electrical hire or cable harness. In various examples, the light-enhanced formboard advantageously reduces cost, improves process flow, and reduces the need for referencing complicated paperwork. The system also advantageously improves first pass quality and makes manual quality checks easier to perform. Further, the system advantageously reduces operator learning curve and enables an operator to perform routing with increased speed and accuracy.

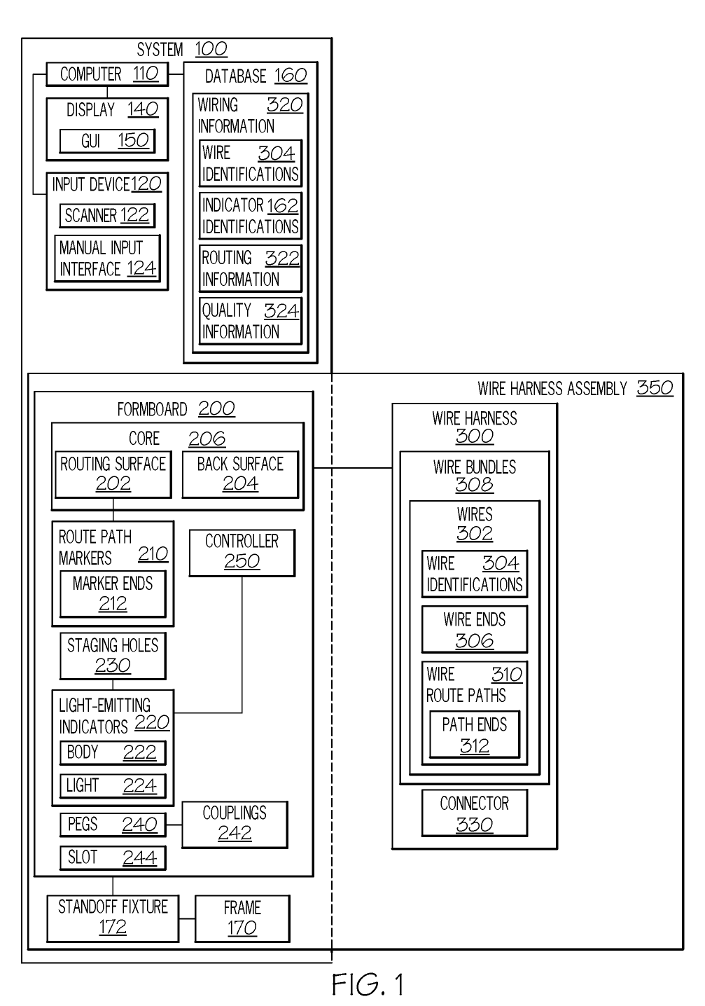

Referring now to FIGS. 1 and 3-18 by way of examples, the present disclosure is directed to a system 100 for assembling or otherwise fabricating a wire harness 300. The following are examples of the system 100, according to the present disclosure. Examples of the system 100 include a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

As illustrated in FIGS. 1 and 3-18, in one or more examples, the system 100 includes a formboard 200. In one or more examples, the formboard 200 incudes a routing surface 202, a plurality of route path markers 210, and a plurality of light-emitting indicators 220. The routing surface 202 is configured to support a plurality of wires 302 of the wire harness 300, for example, during routing of the wires 302, formation of wire bundles 308, and assembly of the wire harness 300 on the formboard 200. The route path markers 210 define a plurality of wire route paths 310 for the wires 302 on the routing surface 202. The light-emitting indicators 220 are integrated with the formboard 200 proximate (e.g., at or near) marker ends 212 of the route path markers 210. Pairs of the light-emitting indicators 220 identify the locations of opposing marker ends 212 of the route path markers 210 and, thus, the locations of opposing path ends 312 of the wire route paths 310.

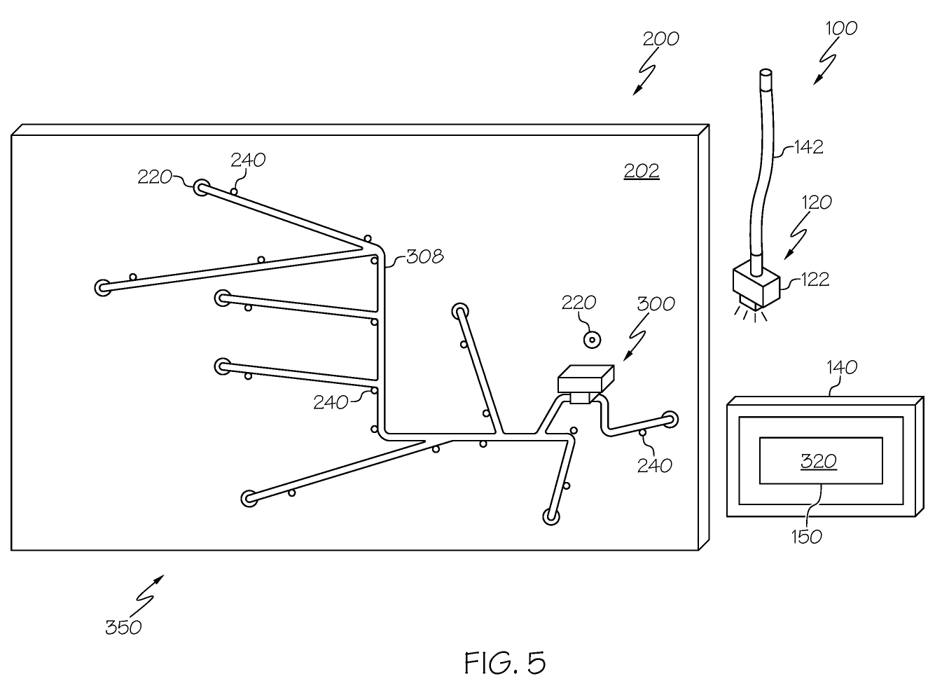

As illustrated in FIGS. 1 and 3-6, the formboard 200 includes or takes the form of any suitable tooling fixture or jig configured to accurately and repeatably guide and secure wire routing during assembly of the wire harness 300 (FIG. 5). In one or more examples, the formboard 200 includes a core 206, for example, taking the form of a generally flat, thin, rectangular piece of rigid or semi-rigid material, such as wood, plastic, metal, foam, composite, or a combination thereof. The core 206 includes or forms the routing surface 202 and a back surface 204, opposite the routing surface 202. In one or more examples, the formboard 200 is an existing forming board or jig that is in use in production of wire harnesses and that is modified with integrated light-enhanced locating features described herein. In one or more examples, the formboard 200 is a newly manufactured forming board or jig for use in production of wire harnesses that is fabricated to include integrated light-enhanced locating features described herein.

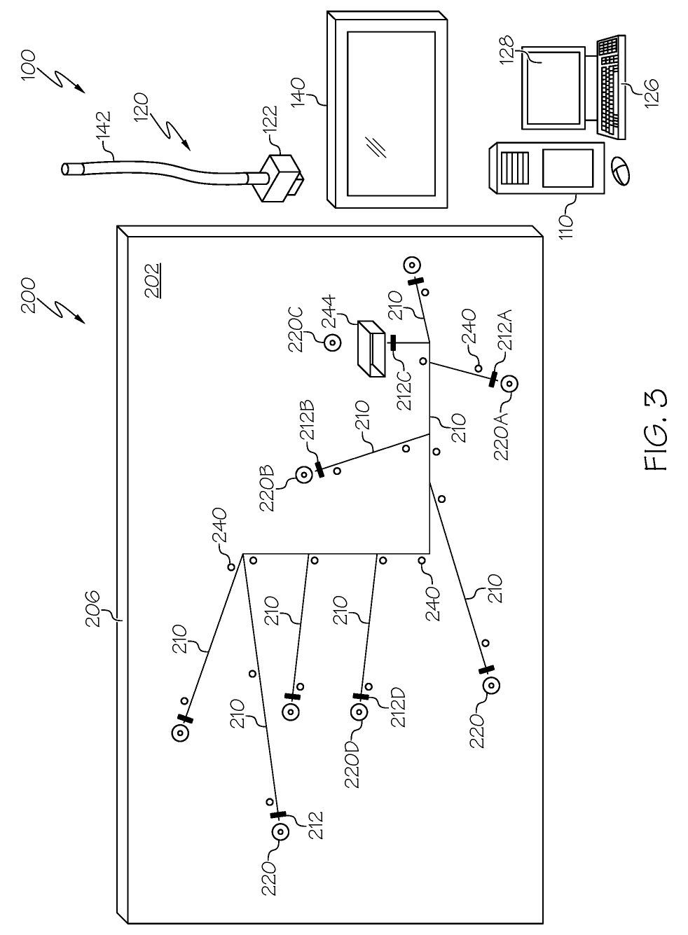

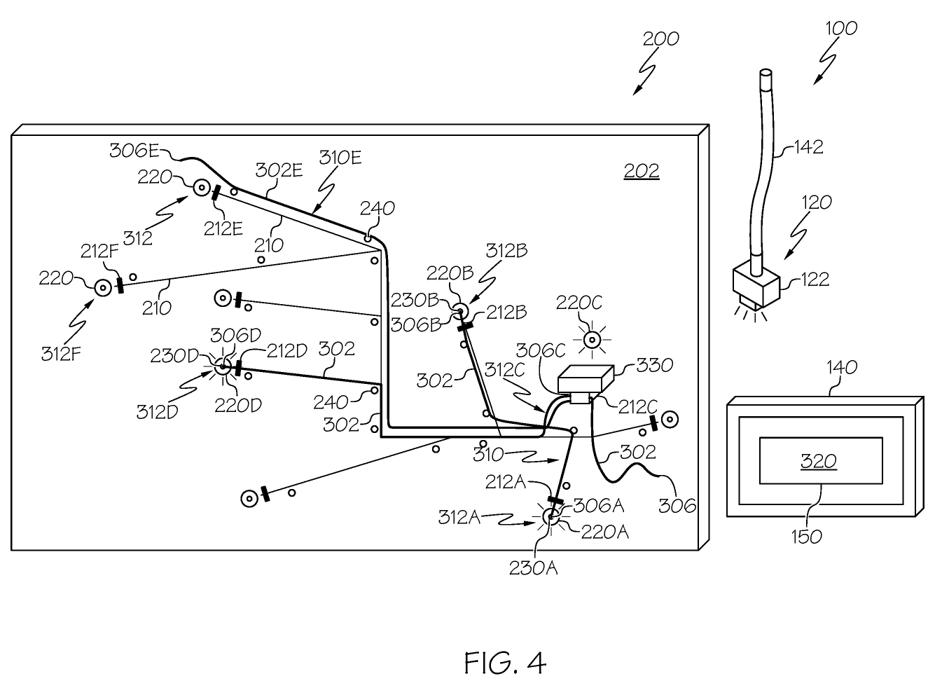

As illustrated in FIGS. 3 and 4, in one or more examples, the route path markers 210 are situated on the routing surface 202 of the formboard 200. The route path markers 210 can be printed on or otherwise applied to the routing surface 202. In one or more examples, each one of the route path markers 210 has two marker ends 212. Each one of the wire route paths 310 has at least two opposing path ends 312. The path ends 312 of each one of the wire route paths 310 correspond to the marker ends 212 of an associated one of the route path markers 210. Each pair of the light-emitting indicators 220 is associated with one of the route path markers 210 and identifies the path ends 312 of an associated one of the wire route paths 310.

In one or more examples, two or more of the route path markers 210 share one of the marker ends 212 (e.g., as shown in FIG. 3). In these examples, two or more of the wire route paths 310 share the location of the path ends 312 (e.g., as shown in FIG. 4). In one or more examples, two or more of the route path markers 210 share segments of a path marking on the routing surface 202 (e.g., as shown in FIG. 3). In these examples, one or more portions of one or more of the wire route paths 310 may overlap one another, for example, such that two or more wires run parallel along their corresponding wire route path 310 before diverging from one another (e.g., as shown in FIG. 4).

In one or more examples, one of the path ends 312 of the wire route path 310 has a temporary location, such as to temporarily hold the wire end 306 of the wire 302 during routing, and a final location, such as to hold the wire end 306 after routing. As an example, wire route path 310E of one or more of the wires 302 can have temporary path end 312E and final path end 312F, as illustrated in FIG. 4. In this example, wire end 306E of the wire 302E is initially routed and temporarily secured at marker end 212E (e.g., one of the marker ends 212) corresponding to temporary path end 312E. Wire end 306E can then be moved and secured at marker end 212F (e.g., another one of the marker ends 212) corresponding to final path end 312F.

In one or more examples, as shown in FIGS. 3 and 4, both ends 306 of one of the wires 302 is free and must be positioned at both the “from” location and the “to” location, which must be identified and located by an operator during wire routing. One of the route path markers 210 includes maker end 212A and opposed marker end 212B (FIG. 3). The wire route path 310 of the wire 302 is associated with the route path marker 210 and includes path end 312A and opposed path end 312B (FIG. 4). Marker end 212A corresponds to path end 312A and represents the “from” location. Marker end 212B corresponds to path end 312B and represents the “to” location. Light-emitting indicator 220A is associated with (e.g., is situated proximate to) and identifies marker end 212A. Illumination or activation of light-emitting indicator 220A visually identifies path end 312A. Light-emitting indicator 220B is associated with (e.g., is situated proximate to) and identifies marker end 212B. Illumination or activation of light-emitting indicator 220A visually identifies path end 312B. During assembly of the wire harness 300, wire end 306A (FIG. 4) of one of the wires 302 is positioned at marker end 212A (e.g., in a staging hole) as indicated by light-emitting indicator 220A. The wire 302 is routed from path end 312A (e.g., “from” location) to path end 312B (e.g., “to” location) along its associated wire route path 310 according to the corresponding route path marker 210. The opposed wire end 306B (FIG. 4) of the wire 302 is positioned at marker end 212B (e.g., in a staging hole) as indicated by light-emitting indicator 220B.

In one or more examples, as shown in FIGS. 3 and 4, wire end 306C (e.g., one wire end 306) of the wire 302 is coupled to an electrical connector 330 of the wire harness 300 and wire end 306D (e.g., opposing wire end 306) of the wire 302 is free and must be positioned at the “to” location (e.g., marker end 212D). In one or more examples, the formboard 200 includes a mount 244 attached to the formboard face (e.g., to the routing surface 202), such as a bracket or peg, that holds the electrical connector 330 in place or other feature formed in or coupled to the core 206 that enables the electrical connector 330 to be temporarily secured to the formboard 200. In these examples, the connector 330 to which one of the ends 306 of the wire 302 is coupled represents the “from” location. One of the route path markers 210 includes marker end 212C and opposed marker end 212D (FIG. 3). The wire route path 310 of the wire 302 is associated with the route path marker 210 and includes path end 312C and opposed path end 312D (FIG. 4). In one or more examples, marker end 212C (e.g., proximate the electrical connector 330) corresponds to path end 312C and represents the “from” location. In this example, the wire end 306C is connected to the electrical connector 330 and the electrical connector 330 forms marker end 212C. Marker end 212D corresponds to path end 312D and represents the “to” location. Light-emitting indicator 220C is associated with (e.g., is situated proximate to) and identifies marker end 212C. Illumination or activation of light-emitting indicator 220C visually identifies path end 312C. Light-emitting indicator 220D is associated with (e.g., is situated proximate to) and identifies marker end 212D. Illumination or activation of light-emitting indicator 220D visually identifies path end 312D. During assembly of the wire harness 300, wire end 306C (FIG. 4) of one of the wires 302 is coupled to the connector 330 at marker end 212C as indicated by light-emitting indicator 220C. The wire 302 is routed from path end 312C, such as from the electrical connector 330, (e.g., “from” location) to path end 312D (e.g., “to” location) along its associated wire route path 310 according to the corresponding route path marker 210. The opposed wire end 306D (FIG. 4) of the wire 302 is positioned at marker end 212D (e.g., in a staging hole) as indicated by light-emitting indicator 220D.

The examples described above can be repeated a number of times for each one of the wires 302 forming the wire harness 300, as illustrated in FIG. 5. It can be appreciated that only a few route path markers 210, a few light-emitting indicators 220, and a few wires 302 are illustrated in the examples depicted in FIGS. 3-5 for the purposes of clarity of illustration. It can be further appreciated that the formboard 200 can include any number of route path markers 210, any number of light-emitting indicators 220, and any number of wires 302 needed to assemble the wire harness 300.

As illustrated in FIG. 1, in one or more examples, the system 100 includes a computer 110. The computer 110 is configured (e.g., programmed or adapted) to activate the pairs of the light-emitting indicators 220 corresponding to wire identifications 304 of the wires 302 such that an activated pair of the light-emitting indicators 220 visually guide the placement or position of opposing wire ends 306 of the wires 302. As an example, upon identification of the wire 302, for example, by its wire identification 304, the computer 110 is programmed to retrieve indicator identifications 162 (e.g., the “from” and “to” locations) associated with the wire 302 and automatically activate the light-emitting indicators 220 corresponding to the indicator identifications 162.

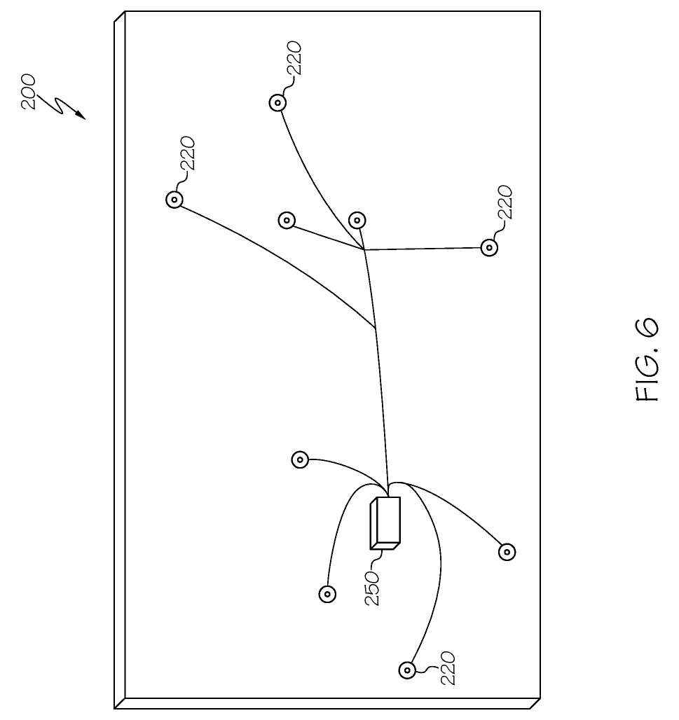

As illustrated in FIGS. 1 and 6, in one or more examples, the formboard 200 includes a controller 250. The controller 250 is in communication with (e.g., is electrically coupled to) the light-emitting indicators 220. The controller 250 is configured to selectively activate the light-emitting indicators 220. In one or more examples, the controller 250 is a suitable electronic device that manages the operation of the light-emitting indicators 220, for example, as instructed by the computer 110. In one or more examples, the controller 250 is configured to allow for dynamic control over brightness, color, effects, timing, and the like of each one of the light-emitting indicators 220. The controller 250 can include a pre-programmed controller, a microcontroller-based controller, or a smart (e.g., Wi-Fi or Bluetooth-enabled) controller. In one or more examples, the controller 250 is coupled to the back surface 204 of the core 206 and is electrically coupled (e.g., via wiring) to the light 224 of each one of the light-emitting indicators 220.

As illustrated in FIGS. 1, 3-5 and 7, in one or more examples, the formboard 200 includes a plurality of staging holes 230. The staging holes 230 are formed in the routing surface 202 of the core 206. In one or more examples, the staging holes 230 are situated proximate (e.g., at or near) the marker ends 212 of the route path markers 210. The staging holes 230 are configured to receive the wire ends 306 of the wires 302 and to temporarily retain or otherwise secure the wire ends 306 of the wires 302 during the wire routing operation. In one or more examples, each one of the light-emitting indicators 220 corresponds to or is associated with one of the staging holes 230.

In one or more examples, the light-emitting indicators 220 are coupled to the core 206 of the formboard 200 proximate (e.g., at or near) the staging holes 230. In one or more examples, the light-emitting indicators 220 are situated in the staging holes 230. In one or more examples, the light-emitting indicators 220 form at least a portion of the staging holes 230. In one or more examples, the staging holes 230 previously exist in the production implementation of the formboard 200 (e.g., currently in use in wire harness assembly) and the light-emitting indicators 220 are integrated to the core 206 of the formboard 200 at or in the staging holes 230. In one or more examples, the staging holes 230 are formed in newly fabricated implementations of the formboard 200 and the light-emitting indicators 220 are integrated to the core 206 of the formboard 200 at or in the staging holes 230.

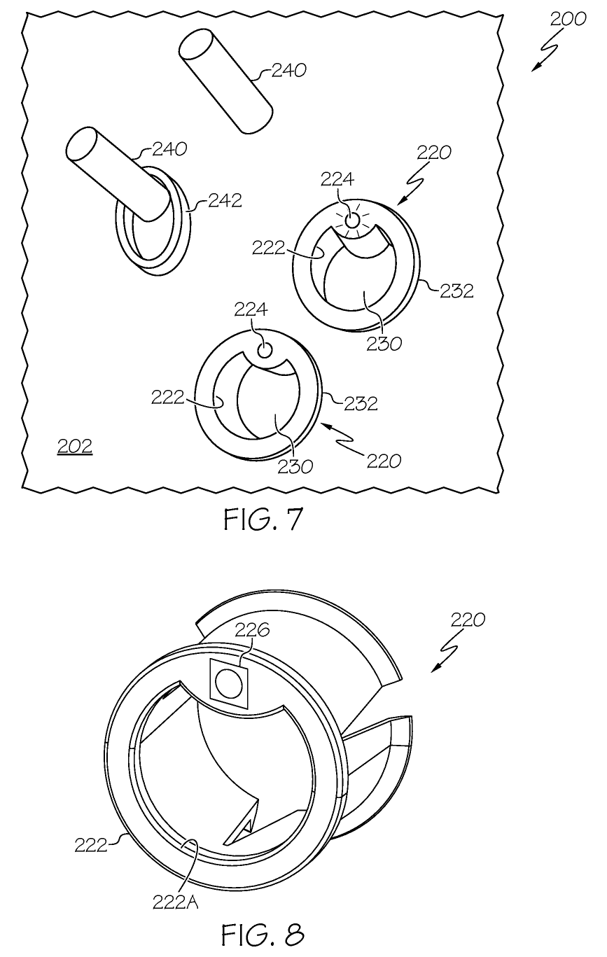

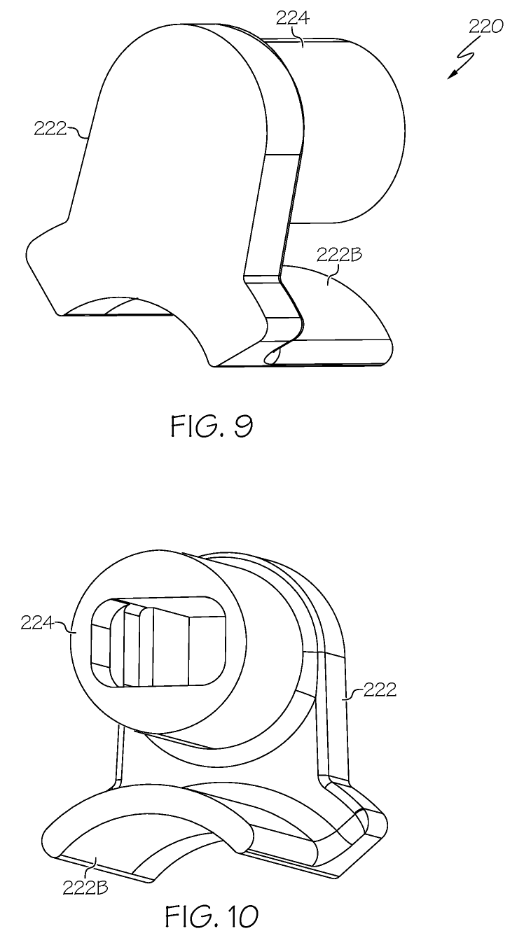

FIG. 7 depicts an example of the light-emitting indicators 220 coupled to or otherwise integrated with the formboard 200. FIG. 8 depicts an example of one of the light-emitting indicators 220 shown in FIG. 7. FIGS. 9 and 10 depict another example of the light-emitting indicator 220. As illustrated in FIGS. 1 and 7-9, each one of the light-emitting indicators 220 includes a body 222 and a light 224. In one or more examples, the light 224 is coupled to the body 222. In one or more example, the light 224 is integrated with (e.g., formed into or encapsulated within) the body 222. In one or more examples, the body 222 is coupled to the core 206.

As illustrated in FIGS. 7 and 8, in one or more examples, at least a portion of the body 222 is tubular (e.g., is hollow and fully enclosed) or includes a tubular portion 222A. In these examples, at least a portion of the light-emitting indicator 220 (e.g., tubular portion 222A of the body 222) forms at least a portion of the staging hole 230. As an example, the body 222 of the light-emitting indicator 220 forms a perimeter of or otherwise lines the staging hole 230. As an example, the core 206 includes a hole 232 formed through the routing surface 202 and configured to receive at least a portion of the body 222. The body 222 of the light-emitting indicator 220 fits within the hole 232 such that body 222 of the light-emitting indicator 220 lines the hole 232 and the hollow interior of the body 222 forms the staging hole 230. In one or more examples, the body 222 includes a slit or other feature that enables the tubular portion of the body 222 to radially contract during insertion of the body 222 into the hole 232 and then radially expand or spring back to its original diameter.

As illustrated in FIGS. 9 and 10, in one or more examples, at least a portion of the body 222 is semi-tubular (e.g., is curved or hollow but not fully enclosed) or includes an arcuate or semi-tubular portion 222B. In these examples, at least a portion of the light-emitting indicator 220 (e.g., semi-tubular portion 222Bof the body 222) forms at least a portion of the staging hole 230. As an example, the body 222 of the light-emitting indicator 220 forms a portion of the perimeter of or lines a portion of the staging hole 230. As an example, the core 206 includes the hole 232 formed in the core 206 and located adjacent to the staging hole 230. In these examples, the hole 232 is configured to receive a portion of the light-emitting indicator 220 such that another portion of the light-emitting indicator 220 is positioned at or in the staging holes 230. In one or more examples, the light-emitting indicator 220 includes a post 226 that extends from the body 222 and is configured to be inserted into the hole 232. A portion of the body 222 of the light-emitting indicator 220 fits within the staging hole 230 such that body 222 of the light-emitting indicator 220 lines a portion of the staging holes 230 and forms a portion of the staging hole 230.

As illustrated in FIGS. 7-9, in one or more examples, the light 224 is encapsulated within the body 222. In these examples, at least a portion of the body 222 of the light-emitting indicator 220 is transparent or semi-transparent (e.g., translucent) such that light emitted from the light 224 passes through the material of the body 222. In one or more examples, the light 224 is a light-emitting diode (LED). However, in other examples, the light 224 can be other types of light-emitting devices or bulbs.

In one or more examples, the light-emitting indicators 220 are continuous. In one or more examples, the light-emitting indicators 220 are configured to blink. In these examples, the timing or speed of the blink is controlled by the controller 250, for example, as instructed by the computer 110 based on wiring information 320 or according to the wire identification 304 of the wire 302 being routed. In one or more examples, the light-emitting indicators 220 are white. In one or more examples, the light-emitting indicators 220 are colored. In one or more examples, the light-emitting indicators 220 are configured to change color, for example, as instructed by the computer 110 based on the wiring information 320 or according to the wire identification 304 of the wire 302 being routed.

As illustrated in FIGS. 1, 3-5 and 7, in one or more examples, the formboard 200 includes a plurality a pegs 240. The pegs 240 are spaced apart and positioned along the route path markers 210. The pegs 240 are configured to temporarily hold the wires 302 in position along the wire route paths 310. In one or more examples, the formboard 200 also includes couplings 242 that are configured to secure the wires 302 to the pegs 240 along the route path markers 210. The couplings 242 can be bands, straps, clips, or the like.

As illustrated in FIGS. 1, 3-5, 14 and 15, in one or more examples, the system 100 includes an input device 120. The input device 120 is configured to receive the wire identifications 304 of the wires 302. In these examples, the computer 110 is configured to automatically activate (e.g., instruct the controller to activate) a select pair of the light-emitting indicators 220 corresponding to a detected one of the wire identifications 304.

As illustrated in FIGS. 1, 3-5, 14 and 15, in one or more examples, the input device 120 includes a scanner 122. In one or more examples, the scanner 122 includes a suitable 2D vision scanner, such as a barcode scanner, an optical character recognition (OCR) scanner, or a pattern recognition scanner, depending on the manner in which the wire identifications 304 are imprinted on the wires 302. The scanner 122 enables the operator to quickly and easily detect and automatically input the wire identification 304 associated with and identifying the wire 302 being routed.

As illustrated in FIGS. 3-5 and 15, in one or more examples, the input device 120 includes a support arm 142. In one or more examples, the support arm 142 is a flexible, adjustable arm designed to hold and position the scanner 122. In these examples, the support arm 142 enables the operator to selectively position the scanner 122 for effectively scanning the wires 302 and detecting the wire identifications 304 during the routing operation and/or during the quality check operation.

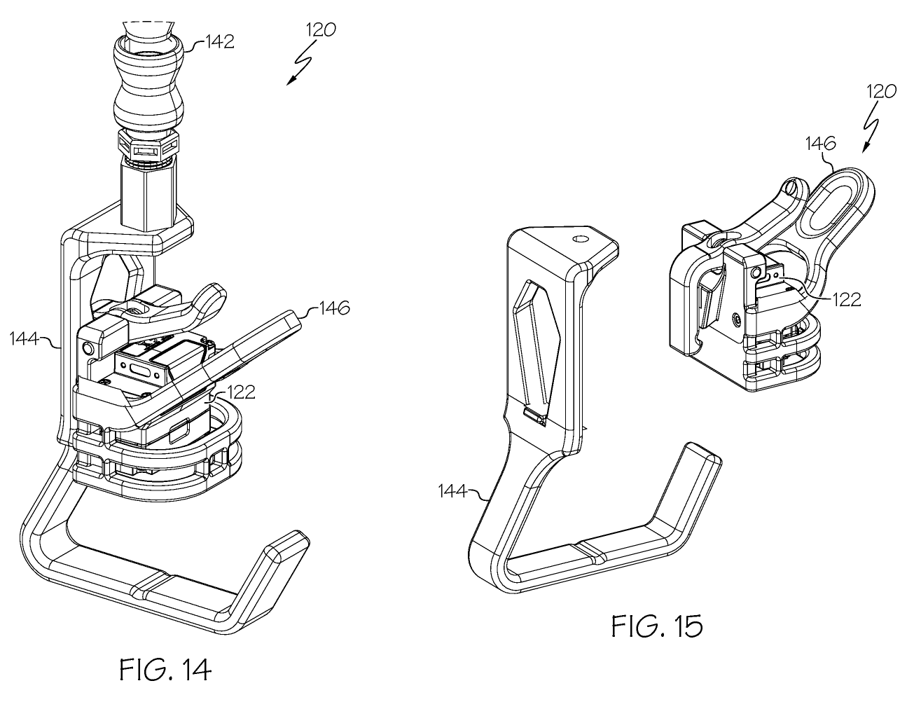

As illustrated in FIGS. 14 and 15, in one or more examples, the input device 120 includes a scan guide 144. The scan guide 144 is coupled to the support arm 142. The scanner 122 is coupled to the scan guide 144. The scan guide 144 provides an indexing surface for properly or optimally positioning the wire 302 relative to the scanner 122 for scanning. In one or more examples, the scanner 122 is removable from (e.g., removably coupled to) the scan guide 144. As an example, the input device 120 includes a bracket 146 that is coupled to or otherwise configured to hold the scanner 122. The bracket 146 is also configured to be easily coupled to and removed from the scan guide 144.

As illustrated in FIGS. 1 and 3, in one or more examples, the input device 120 includes a manual input interface 124, such as a keyboard 126, a mouse, a touchscreen 128, or other device. The manual input interface 124 enables the operator to manually input the wire identification 304 associated with and identifying the wire 302 being routed.

As illustrated in FIG. 1, in one or more examples, the system 100 includes a database 160. The database 160 stores wiring information 320 about the wire harness 300. In one or more examples, the wiring information 320 includes the wire identifications 304 and the indicator identifications 162 of the light-emitting indicators 220 corresponding to the wire identifications 304. In one or more examples, the computer 110 is configured to retrieve the wiring information 320 from the database 160 and manage the wiring information 320 about the wire harness 300. In one or more examples, the database 160 stores routing information 322 associated with each one of the wires 302 that instruct the operator through the wire routing operation. In one or more examples, the database 160 stores quality information 324 associated with the completed wire harness 300 that instructs the operator through a quality check operation.

As illustrated in FIGS. 1 and 3-5, in one or more examples, the system 100 includes a display 140. In these examples, the computer 110 is configured to display the wiring information 320 via a graphical user interface 150 (FIGS. 1, 4 and 5) on the display 140. In one or more examples, the display 140 displays the routing information 322 via the graphical user interface 150 during the wire routing operation of each wire 302. In one or more examples, the display 140 displays the quality information 324 via the graphical user interface 150 during the quality check operation of the wire harness 300.

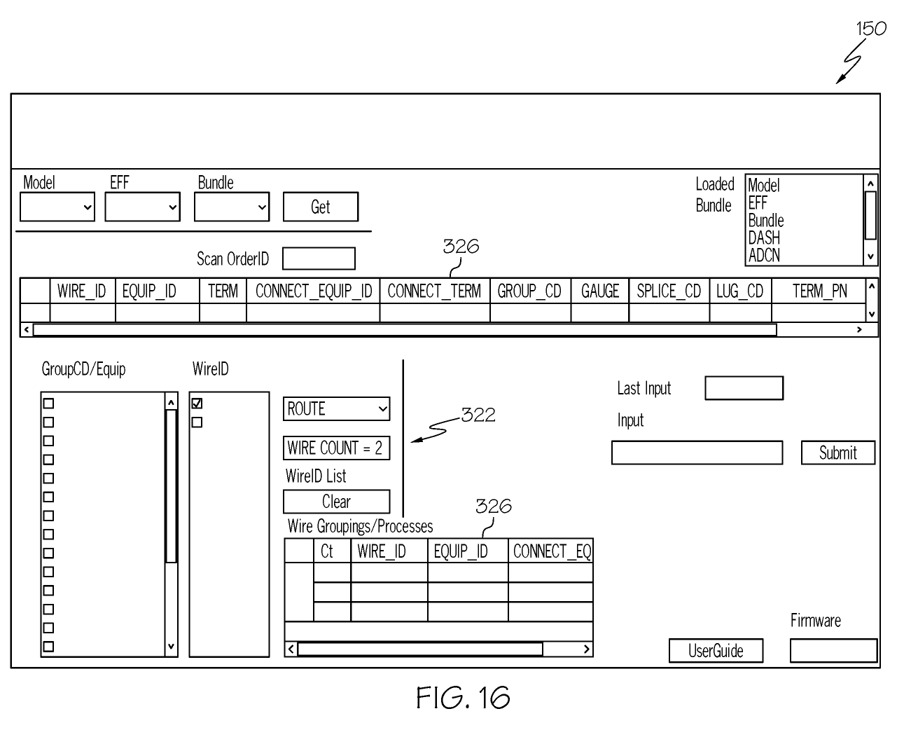

FIG. 16 illustrates an example of the graphical user interface 150 that can be provided by a wire routing application executed by the computer 110 for displaying the routing information 322 during the wire routing operation. In one or more examples, the wire routing application automatically populates one or more wire routing fields 326 or subfields in response to input of the wire identification 304 to instruct the operator through the routing operation. Alternatively, the operator can use the graphical user interface 150 to select a particular wire ID (e.g., wire identification 304) corresponding to one of the wires 302 and the wire routing application populates various wire routing fields 326 or subfields. Specific wire information (e.g., wiring information 320, routing information 322, etc.), such as wire count, identification information, wire information, last wire routed information, wire group identification, and the like, can be presented in the wire routing fields 326. The wire routing application automatically updates the information displayed in the wire routing fields 326 when a new wire identification 304 is inputted (e.g., a new wire 302 is scanned).

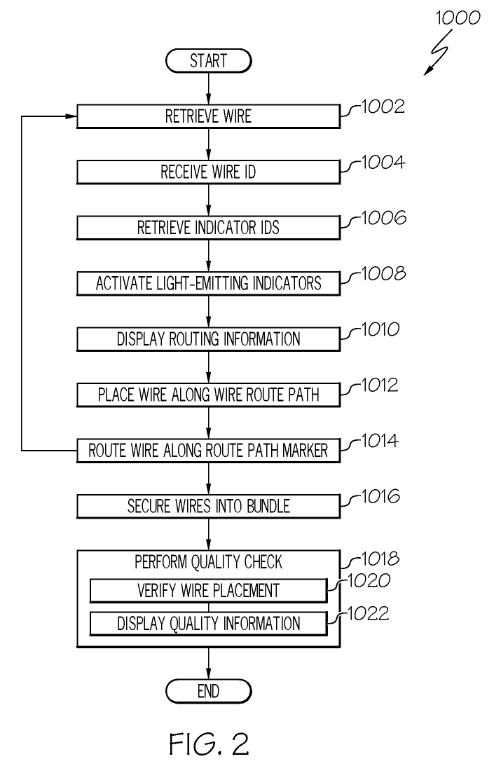

As an example of the wire routing operation (e.g., shown at 1002-1014 of the method 1000 illustrated in FIG. 2) using the wire routing application executed by the computer 110 and displaying the routing information 322 by the graphical user interface 150 (e.g., illustrated in FIG. 16), the operator scans a barcode on the wire 302 to get the corresponding wire identification 304. The wire routing application retrieves associated equipment names or routing locations (e.g., “from” and “to” locations) from the wire identification 304. The wire routing application converts the routing location (e.g., equipment name in a mapping table) to the corresponding indicator identification 162. The light-emitting indicator 220 associated with the mapped indicator identification 162 is activated. The operator routes the wire 302 with assistance of the activated light-emitting indicators 220.

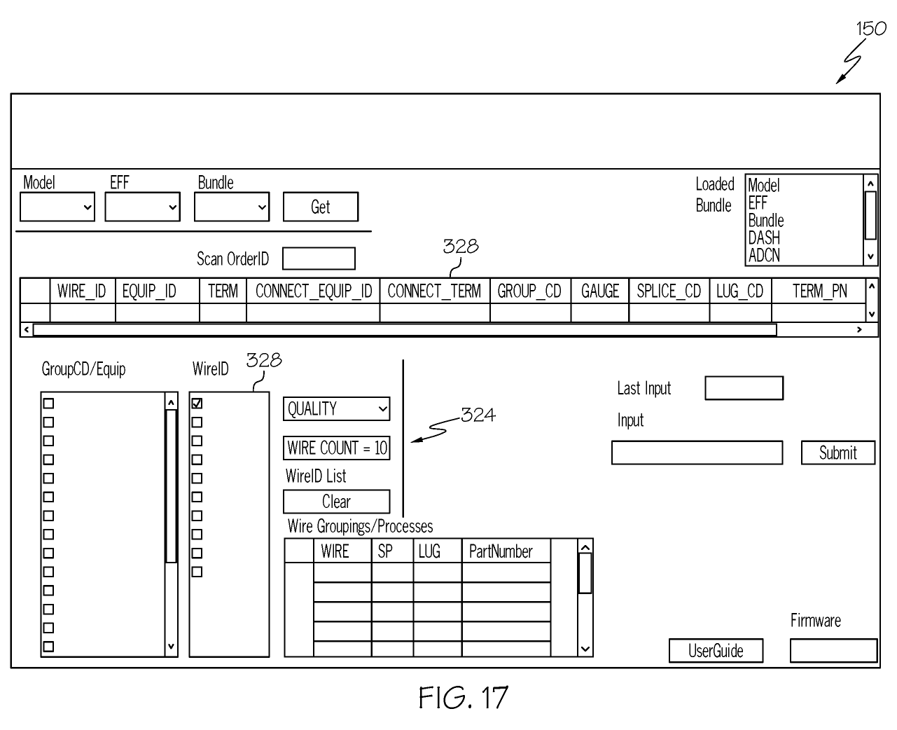

FIG. 17 illustrates an example of the graphical user interface 150 that can be provided by a quality checking application executed by the computer 110 for displaying the quality information 324 during the quality checking operation. In one or more examples, the quality checking application automatically populates one or more quality check fields 328 or subfields in response to input of the wire identification 304 to instruct the operator through the quality check operation. Alternatively, the operator can use the graphical user interface 150 to select a particular wire ID (e.g., wire identification 304) corresponding to one of the wires 302 and the wire routing application populates various quality check fields 328 or subfields. Specific wire information (e.g., wiring information 320, quality information 324, etc.), such as wire count, identification information, wire information, last wire routed information, wire group identification, and the like, can be presented in the quality check fields 328. The quality checking application automatically updates the information displayed in the quality check fields 328 when a new wire identification 304 is inputted (e.g., a new wire 302 is scanned). As another example, the quality checking operation is organized by group (e.g., equipment name) or routing locations. In these examples, system 100 activated one of the light-emitting indicators 220 at a particular routing location (e.g., corresponding to a particular marker end 212 or path end 312) and displays a checklist of the wires 302 that should be at that location. The operator then scans every wire at that location (e.g., in the staging hole 230 associated with that routing location), which is checked against the list of wires. After all the wires 302 at a particular routing location (e.g. in a particular staging hole 230 associated with the marker end 212 or path end 312) are scanned successfully, the system 100 automatically moves to the next routing location and illuminates light-emitting indicator 220 associated with that routing location.

As an example of the quality checking operation (e.g., shown at 1018 of the method 1000 illustrated in FIG. 2) using the quality checking application executed by the computer 110 and displaying the quality information 324 by the graphical user interface 150 (e.g., illustrated in FIG. 17), the operator selects the quality checking application. The application automatically selects equipment, group, or routing location from a quality check table (e.g., mapping table stored in database). The application converts the equipment name, group, or routing location to the indicator identification 162. The light-emitting indicator 220 associated with the mapped indicator identification 162 is activated. The operator scans all wires 302 in that equipment location and each wire 302 is verified in application. In one or more examples, if the wire 302 is in an incorrect location, the application and the associated light-emitting indicator 220 will indicate a failure. In other examples, if the wire 302 is in an incorrect location, the application and the associated incorrect light-emitting indicator 220 will indicate a failure and a correct one light-emitting indicator 220 will activate to indicate (e.g., illuminate) the correct routing location for the wire end 306 (e.g. staging hole 230 associated with correct marker end 212 or path end 312) without having to go back into the routing application and rescanning the wire 302. Once all wires 320 have been scanned for that equipment location the light-emitting indicator 220 will turn off and the next light-emitting indicator 220 in the quality check table will illuminate.

As illustrated in FIGS. 1 and 11-13, in one or more examples, the system 100 includes a frame 170 and a standoff fixture 172. The frame 170 is configured to support the formboard 200 during wire routing and wire harness assembly. The standoff fixture 172 is configured to couple the formboard 200 to the frame 170 and to separate or space the back surface 204 away from the frame 170. Separation or spacing of the back surface 204 from the frame 170 protects the controller 250, electrical wiring to the light-emitting indicators 220, and any other components coupled or mounted to the back surface 204 of the core 206.

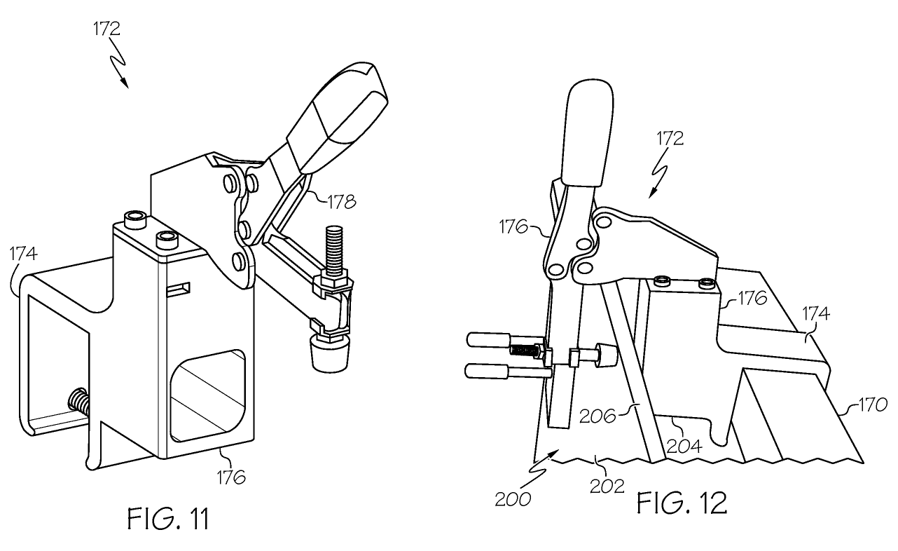

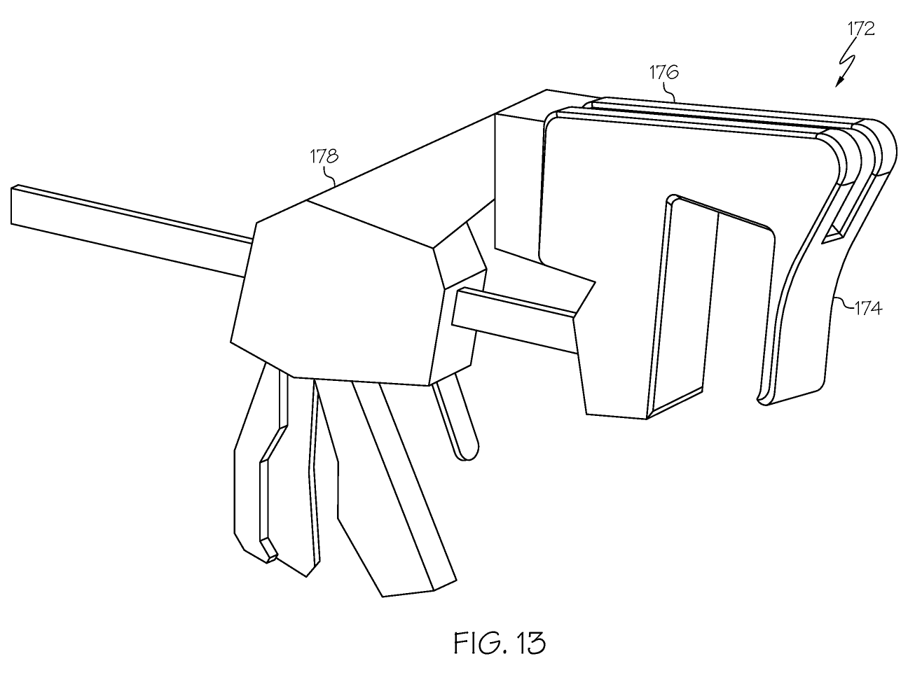

In one or more examples, as shown in FIGS. 11-13, the standoff fixture 172 includes a clip 174, a standoff 176, and a clamp 178. The clip 174 includes any suitable device or mechanism configured to be secured to the core 206 of the formboard 200. In one or more examples, the clip 174 includes a U-shaped body that retains the core 206, for example, between a pair of clip arms by tension. In one or more examples, the standoff 176 is coupled to or extends outwardly from the clip 174. In one or more examples, the clamp 178 is coupled to the standoff 176 such that the standoff 176 spaces apart the clamp 178 from the clip 174. The clamp 178 includes any suitable device or mechanism configured to secure the core 206 to the standoff fixture 172, such as against the clip 174. In one or more examples, the clamp 178 is a C-clamp, a speed clamp (e.g., as shown in FIG. 13), a pull over latch clamp (e.g., as shown in FIGS. 11 and 12), and the like.

Referring now to FIGS. 1 and 3-10 by way of examples, the present disclosure is directed to the formboard 200 for assembling or otherwise fabricating the wire harness 300. The following are examples of the formboard 200, according to the present disclosure. Examples of the formboard 200 include a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

As illustrated in FIGS. 1 and 3-6, in one or more examples, the formboard 200 includes the routing surface 202 configured to support the wires 302 of the wire harness 300 during assembly of the wire harness 300. The formboard 200 includes the route path markers 210 defining the wire route paths 310 on the routing surface 202. The formboard 200 includes the light-emitting indicators 220 integrated at marker ends 212 of the route path markers 210. Pairs (e.g., selectively associated pairs) of the light-emitting indicators 220 are activated to identify opposing path ends 312 of the wire route paths 310.

As illustrated in FIGS. 1 and 3-6, in one or more examples, the formboard 200 includes the staging holes 230 that are formed in the routing surface 202 at the marker ends 212 of the route path markers 210. The staging holes 230 are configured to receive the wire ends 306 of the wires 302. In one or more examples, each one of the light-emitting indicators 220 includes the body 222 that forms at least a portion of one of the staging holes 230. Each one of the light-emitting indicators 220 also includes the light 224 that is coupled to or integrated with the body 222.

As illustrated in FIGS. 1 and 6, in one or more examples, the formboard 200 includes the controller 250. The controller 250 is in communication with (e.g., is electrically coupled to) the light-emitting indicators 220. The controller 250 is configured to selectively activate the light-emitting indicators 220.

Referring now to FIGS. 1 and 5 by way of examples, the present disclosure is directed to a wire harness system 350. The following are examples of the wire harness system 350, according to the present disclosure. Examples of the wire harness system 350 include a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

As illustrated in FIGS. 1 and 5, in one or more examples, the wire harness system 350 includes the formboard 200 and the wire harness 300 assembled on the formboard 200. The formboard 200 includes the routing surface 202 configured to support the wires 302 of the wire harness 300 during assembly of the wire harness 300. The formboard 200 includes the route path markers 210 defining the wire route paths 310 on the routing surface 202. The formboard 200 includes the light-emitting indicators 220 integrated at marker ends 212 of the route path markers 210. Pairs (e.g., selectively associated pairs) of the light-emitting indicators 220 are activated to identify opposing path ends 312 of the wire route paths 310. The wire harness 300 includes wires 302 placed on the routing surface 202 and routed according to the route path markers 210 to form a number of wire bundles 308 along the wire route paths 310. The wire ends 306 of at least some of the wires 302 (or of the wire bundles 308) are situated in the staging holes 230 of the formboard 200. The wire harness 300 also includes various other components common to wire harnesses, such as, but not limited to, straps, connectors, current return networks, fittings, spanners, and the like.

Referring now to FIG. 2, by way of examples, present disclosure is also directed to a method 1000 for assembling or otherwise fabricating the wire harness 300. The following are examples of the method 1000, according to the present disclosure. In one or more examples, the method 1000 is implemented using the system 100 (FIGS. 1 and 3-18) and/or the formboard 200 (FIGS. 1 and 3-10). Examples of the method 1000 include a number of elements, steps, operations, or processes. Not all of the elements, steps, operations, or processes described or illustrated in one example are required in that example. Some or all of the elements, steps, operations, or processes described or illustrated in one example can be combined with other examples in various ways without the need to include other elements, steps, operations, or processes described in those other examples, even though such combination or combinations are not explicitly described or illustrated by example herein.

In one or more examples, the method 1000 includes a step of retrieving 1002 the wire 302 to be routed on the routing surface 202 of the formboard 200. The wire 302 can be provided as part of a group of wires or other wire harness assembly kit.

In one or more examples, the method 1000 includes a step of receiving 1004 the wire identification 304 corresponding to the wire 302 to be routed. In one or more examples, the wire identification 304 for the wire 302 is input by the operator using the input device 120, such as by scanning a code (e.g., barcode, alphanumeric characters, etc.) situated on the wire 302.

In one or more examples, the method 1000 includes a step of retrieving 1006 the indicator identifications 162 of the light-emitting indicators 220 associated with the locations of the path ends 312 of the wire route paths 310 corresponding to the wire 302 being routed (e.g., the wire identification 304). In one or more examples, the indicator identifications 162 and the wire identifications 304 are stored on the database 160 and retrieved by the computer 110 in response to inputting the wire identifications 304.

In one or more examples, the method 1000 includes a step of selectively activating 1008 a pair of light-emitting indicators 220 on the formboard 200 corresponding to the wire identification 304. The activated light-emitting indicators 220 are proximate (e.g., at, near, or in) and visually identify the marker ends 212 of the route path markers 210 associated with the wire route paths 310. The light-emitting indicators 220 that are activated are identified and selected based on the retrieved indicator identifications 162.

In one or more examples, the method 1000 includes a step of displaying 1010 the routing information 322 corresponding to the wire 302 on the graphical user interface 150. In one or more examples, the step of displaying 1010 includes a step of populating the routing information 322 and/or the wire routing fields 326 of the graphical user interface 150 displayed to the operator, for example, on the display 140. The routing information 322 and the wire routing fields 326 provide information and instructions to the operator during the wire routing operation.

In one or more examples, the method 1000 includes a step of placing 1012 the wire 302 along the wire route path 310 extending between the pair of light-emitting indicators 220. The wire route path 310 is indicated by one of the route path markers 210 that corresponds to the wire 302 (e.g., the wire identification 304). The route path marker 210 extends between the activated pair of the light-emitting indicators 220 that are situated proximate the marker ends 212 of the route path marker 210. Generally, method 1000, such as the step of placing 1012, includes a step of routing 1014 the wire 302 along the route path marker 210 between the marker ends 212 of the route path marker 210 as indicated by the activated pair of light-emitting indicators 220.

As illustrated in FIG. 4, in one or more examples, according to the method 1000, the step of placing 1012 and/or routing 1014 the wire 302 includes a step of locating the marker end 212A and marker end 212B of the route path marker 210 corresponding to the wire 302. The location of the marker end 212A and marker end 212B are visually indicated by the activated pair of the light-emitting indicators 220. The step of placing 1012 and/or routing 1014 the wire 302 includes a step of securing (e.g., inserting) wire end 306A of the wire 302 in staging hole 230A in the formboard 200 associated with light-emitting indicator 220A of the activated pair of light-emitting indicators 220. The step of placing 1012 and/or routing 1014 the wire 302 includes a step routing the wire 302 along the route path marker 210 on the routing surface 202 of the formboard 200 associated with the wire route path 310 of the wire 302 between the activated pair of the light-emitting indicators 220. The step of placing 1012 and/or routing 1014 the wire 302 includes a step of securing (e.g., inserting) wire end 306B of the wire 302 into staging hole 230B in the formboard 200 associated with light-emitting indicator 220B of the activated pair of light-emitting indicators 220.

As illustrated in FIG. 4, in one or more examples, according to the method 1000, the step of placing 1012 and/or routing 1014 the wire 302 includes a step of locating the marker end 212C and marker end 212D of the route path marker 210 corresponding to the wire 302. In these examples, wire end 306C is coupled to the electrical connector 330 and is associated with light-emitting indicator 220C of the activated pair of light-emitting indicators 220. The step of placing 1012 and/or routing 1014 the wire 302 includes a step routing the wire 302 along the route path marker 210 on the routing surface 202 of the formboard 200 associated with the wire route path 310 of the wire 302 between the activated pair of the light-emitting indicators 220. The step of placing 1012 and/or routing 1014 the wire 302 includes a step of securing (e.g., inserting) wire end 306D of the wire 302 into staging hole 230D in the formboard 200 associated with light-emitting indicator 220D of the activated pair of light-emitting indicators 220.

In one or more examples, according to the method 1000, the steps described above are repeated a number of times for each one of the wires 302 forming the wire harness 300. As an example, the method 1000 includes a step of retrieving additional wires 302, a step of receiving additional wire identifications 304 corresponding to the additional wires 302 to be routed, a step of retrieving additional indicator identifications 162, a step of selectively activating different pairs of light-emitting indicators 220 on the formboard 200 corresponding to the wire identifications 304, a step of displaying the routing information 322 associated with the additional wires 302, and a step of placing and/or routine the wires 302 along the wire route paths 310 extending between the pairs of light-emitting indicators 220.

In one or more examples, the method 1000 includes a step of securing 1016 the wires 302 into the wire bundle 308. As an example, the wires 302 of one or more wire bundles 308 are secured using straps, clamps, spanners, connectors, and the like of the wire harness 300.

In one or more examples, the method 1000 includes a step of performing 1018 a quality check of the wire harness 300. In one or more examples, quality check includes a step of verifying 1020 placement of the wires 302. In one or more examples, placement of each one of the wires 302 is manually checked to ensure the wire 302 is in the correct location, for example, that the wire ends 306 are in the staging holes 230 at the correct marker ends 212, that the correct number of wires 302 is in the staging holes 230 at the correct marker ends 212, etc.

In one or more examples, the method 1000 includes a step of displaying 1022 quality information 324 corresponding to the wire bundle 308 on the graphical user interface 150. In one or more examples, the step of displaying 1022 includes a step of populating the quality information 324 and/or the quality check fields 328 of the graphical user interface 150 displayed to the operator, for example, on the display 140. The quality information 324 and the quality check fields 328 provide information and instructions to the operator during the quality checking operation.

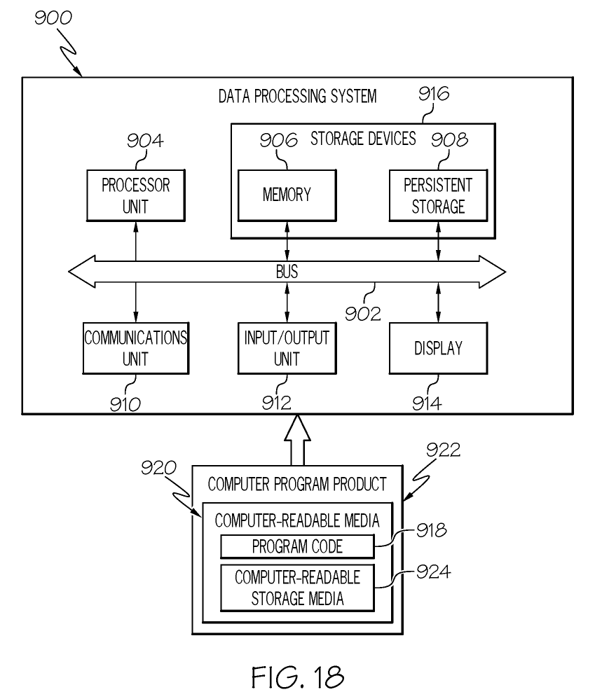

FIG. 18 illustrates an example of a data processing system 900. In one or more examples, the computer 110 (FIG. 1) includes or takes the form of the data processing system 900. In one or more examples, the data processing system 900 includes a communications framework 902, which provides communications between at least one processor 904, one or more storage devices 916, such as memory 906 and/or persistent storage 908, a communications unit 910, an input/output unit 912 (I/O unit), and a display 914. In this example, the communications framework 902 takes the form of a bus system. The processor 904 serves to execute instructions from software or other applications that can be loaded into the memory 906. In one or more examples, the processor 904 is a number of processor units, a multi-processor core, or some other type of processor, depending on the particular implementation. The memory 906 and the persistent storage 908 are examples of the storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. The storage devices 916 may also be referred to as computer readable storage devices in one or more examples. The memory 906 is, for example, a random-access memory or any other suitable volatile or non-volatile storage device. The persistent storage 908 can take various forms, depending on the particular implementation. For example, the persistent storage 908 contains one or more components or devices. For example, the persistent storage 908 is a hard drive, a solid-state hard drive, a flash memory, a rewritable optical disk, a rewritable magnetic tape, or some combination of the above. The media used by the persistent storage 908 also can be removable. For example, a removable hard drive can be used for the persistent storage 908.

The communications unit 910 provides for communications with other systems or devices, such as the input device 120, display 140, or other computer systems. In one or more examples, the communications unit 910 is a network interface card. Input/output unit 912 allows for input and output of data with other devices that can be connected to the data processing system 900. As an example, the input/output unit 912 provides a connection for user input through at least one of a keyboard, a mouse, or some other suitable input device. Further, the input/output unit 912 can send output to a printer. The display 914 provides a mechanism to display information to a user. For example, display 914 is an example of the display 140 and the graphic user interface 150 is displayed to a user by the display 914.

Instructions for at least one of the operating system, applications, or programs can be located in the storage devices 916, which are in communication with the processor 904 through the communications framework 902. The processes of the various examples and operations described herein can be performed by the processor 904 using computer-implemented instructions, which can be located in a memory, such as the memory 906. The instructions can be referred to as program code, computer usable program code, or computer readable program code that can be read and executed by a processor of the processor 904. The program code in the different examples can be embodied on different physical or computer readable storage media, such as the memory 906 or the persistent storage 908.

In one or more examples, program code 918 is located in a functional form on computer readable media 920 that is selectively removable and can be loaded onto or transferred to the data processing system 900 for execution by the processor 904. In one or more examples, the program code 918 and computer readable media 920 form the computer program product 922. In one or more examples, the computer readable media 920 is computer readable storage media 924. In one or more examples, the computer readable storage media 924 is a physical or tangible storage device used to store the program code 918 rather than a medium that propagates or transmits the program code 918. Alternatively, the program code 918 can be transferred to the data processing system 900 using a computer readable signal media. The computer readable signal media can be, for example, a propagated data signal containing the program code 918. For example, the computer readable signal media can be at least one of an electromagnetic signal, an optical signal, or any other suitable type of signal. These signals can be transmitted over at least one of communications links, such as wireless communications links, optical fiber cable, coaxial cable, a wire, or any other suitable type of communications link.

The different components illustrated for data processing system 900 are not meant to provide architectural limitations to the manner in which different examples can be implemented. The different examples can be implemented in a data processing system including components in addition to or in place of those illustrated for the data processing system 900. Other components shown in FIG. 18 can be varied from the examples shown. The different examples can be implemented using any hardware device or system capable of running the program code 918.

Additionally, various components of the computer 110 and/or the data processing system 900 may be described as modules or applications. For the purpose of the present disclosure, the term “module” includes hardware, software or a combination of hardware and software. As an example, a module can include one or more circuits configured to perform or execute the described functions or operations of the executed processes described herein (e.g., the method 1000). As another example, a module includes a processor, a storage device (e.g., a memory), and computer-readable storage medium having instructions that, when executed by the processor causes the processor to perform or execute the described functions and operations. In one or more examples, a module takes the form of the program code 918 and the computer readable media 920 together forming the computer program product 922.

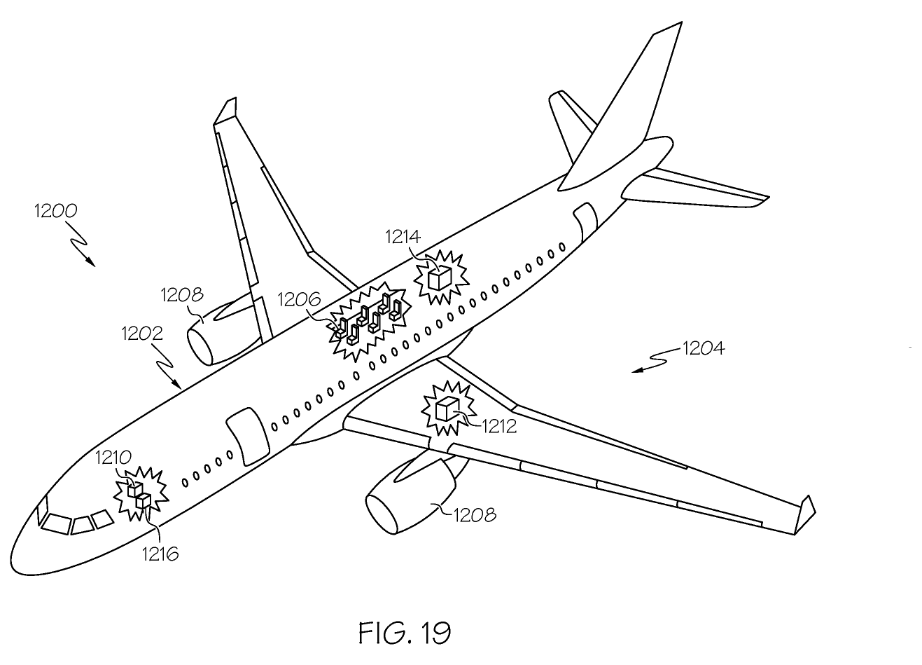

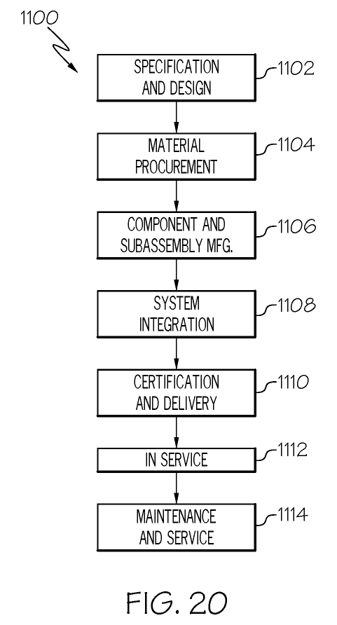

Referring now to FIGS. 19 and 20 examples of the system 100, the formboard 200, the wire harness system 350 and the method 1000, described herein, may be related to, or used in the context of, an aircraft 1200, as schematically illustrated in FIG. 19, and the aerospace manufacturing and service method 1100, as shown in the flow diagram of FIG. 20. As an example, the aircraft 1200 and/or the manufacturing and service method 1100 may utilize wire harnesses that are assembled using the system 100 and/or the formboard 200 and/or according to the method 1000.

Referring to FIG. 19, which illustrates an example of the aircraft 1200. The aircraft 1200 can be any aerospace vehicle or platform. In one or more examples, the aircraft 1200 includes the airframe 1202 having the interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to the airframe 1202 of the aircraft 1200. In yet other examples, the onboard systems 1204 also include one or more other systems 1216, such as, but not limited to, communications systems, avionics systems, software distribution systems, network communications systems, passenger information/entertainment systems, guidance systems, radar systems, weapons systems, and the like. The aircraft 1200 can include various configurations of wire harnesses that are assembled using the system 100 or the formboard 200 and/or according to the method 1000.

Referring to FIG. 20, during pre-production of the aircraft 1200, the manufacturing and service method 1100 includes specification and design 1102 of the aircraft 1200 and material procurement 1104. During production of the aircraft 1200, component and subassembly manufacturing 1106 and system integration 1108 of the aircraft 1200 take place. Thereafter, the aircraft 1200 goes through certification and delivery 1110 to be placed in service 1112. Routine maintenance and service 1114 includes modification, reconfiguration, refurbishment, etc. of one or more systems of the aircraft 1200.

Each of the processes of the manufacturing and service method 1100 illustrated in FIG. 20 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Examples of the system 100, formboard 200, and method 1000, shown and described herein, may be employed during any one or more of the stages of the manufacturing and service method 1100 shown in the flow diagram illustrated by FIG. 20. In an example, wire harnesses (e.g., wire harness 300 or wire harness systems 350) of the aircraft 1200 can be manufactured using the system 100 or formboard 200 and/or according to the method 1000 during a portion of component and subassembly manufacturing 1106 and/or system integration 1108. Further, wire harnesses (e.g., wire harness 300 or wire harness systems 350) of the aircraft 1200 can be manufactured using the system 100 or formboard 200 and/or according to the method 1000 while the aircraft 1200 is in service 1112. Also, wire harnesses (e.g., wire harness 300 or wire harness systems 350) of the aircraft 1200 can be manufactured using the system 100 or formboard 200 and/or according to the method 1000 during system integration 1108 and certification and delivery 1110. Similarly, wire harnesses (e.g., wire harness 300 or wire harness systems ##) of the aircraft 1200 can be manufactured using the system 100 or formboard 200 and/or according to the method 1000 while the aircraft 1200 is in service 1112 and during maintenance and service 1114.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms "first," "second," “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1 and 3-19, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1 and 3-19, referred to above, need to be included in every example and not all elements, features, and/or components described herein are necessarily depicted in each illustrative example. Accordingly, some of the elements, features, and/or components described and illustrated in FIGS. 1 and 3-19 may be combined in various ways without the need to include other features described and illustrated in FIGS. 1 and 3-19, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1 and 3-19, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1 and 3-19, and such elements, features, and/or components may not be discussed in detail herein with reference to each of FIGS. 1 and 3-19. Similarly, all elements, features, and/or components may not be labeled in each of FIGS. 1 and 3-19, but reference numerals associated therewith may be utilized herein for consistency.

In FIGS. 2 and 20, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 2 and 20 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need to be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the system 100, the formboard 200, the wire harness system 350 and the method 1000 have been shown and described, modifications may occur to those skilled in the art upon reading the specification. The present application includes such modifications and is limited only by the scope of the claims.

What is claimed is:

1. A system comprising:
a formboard comprising:
a routing surface configured to support wires of a wire harness during assembly;
a plurality of route path markers defining a plurality of wire route paths on the routing surface; and
a plurality of light-emitting indicators integrated at marker ends of the route path markers, wherein pairs of the light-emitting indicators identify opposing path ends of the wire route paths; and
a computer configured to activate the pairs of the light-emitting indicators corresponding to wire identifications of the wires such that an activated pair of the light-emitting indicators visually guide placement of opposing wire ends of the wires.

2. The system of claim 1, wherein:
the formboard further comprises a plurality of staging holes formed in the routing surface at the marker ends of the route path markers and configured to receive the wire ends of the wires; and
each one of the light-emitting indicators is associated with an associated one of the staging holes.

3. The system of claim 2, wherein each one of the light-emitting indicators comprises:
a body forming at least a portion of one of the staging holes; and
a light integrated with the body.

4. The system of claim 3, wherein:
the body is at least semi-transparent; and
the light is encapsulated within the body.

5. The system of claim 1, wherein the formboard further comprises a plurality a pegs positioned along the route path markers and configured to temporarily hold the wires in position along the wire route paths.

6. The system of claim 1, further comprising an input device configured to receive the wire identifications of the wires,
wherein the computer is configured to activate a select pair of the light-emitting indicators corresponding to a detected one of the wire identifications.

7. The system of claim 6, wherein the input device comprises at least one of a scanner and a manual input interface.

8. The system of claim 1, further comprising a database storing wiring information about the wire harness, the wiring information comprising the wire identifications and indicator identifications of the light-emitting indicators corresponding to the wire identifications.

9. The system of claim 8, wherein the computer is configured to manage the wiring information about the wire harness.

10. The system of claim 9, further comprising a display, wherein the computer is configured to display the wiring information via a graphical user interface on the display.

11. The system of claim 1, wherein the light-emitting indicators are configured to blink or change color.

12. The system of claim 1, further comprising:
a frame that supports the formboard; and
a standoff fixture configured to couple the formboard to the frame.

13. A formboard comprising:
a routing surface configured to support wires of a wire harness during assembly;
a plurality of route path markers defining a plurality of wire route paths on the routing surface; and
a plurality of light-emitting indicators integrated at marker ends of the route path markers, wherein pairs of the light-emitting indicators are activated to identify opposing path ends of the wire route paths.

14. The formboard of claim 13, further comprising a plurality of staging holes formed in the routing surface at the marker ends of the route path markers and configured to receive the wire ends of the wires,
wherein each one of the light-emitting indicators comprises:
a body forming one of the staging holes; and
a light integrated with the body.

15. The formboard of claim 13, further comprising a controller in communication with the light-emitting indicators and configured to selectively activate the light-emitting indicators.

16. A method for assembling a wire harness using a formboard, the method comprising:
receiving a wire identification corresponding to a wire to be routed;
selectively activating a pair of light-emitting indicators on the formboard corresponding to the wire identification; and
placing the wire along a wire route path extending between the pair of light-emitting indicators.

17. The method of claim 16, wherein placing the wire comprises:
inserting a first end of the wire into a first staging hole in the formboard associated with a first light-emitting indicator of the pair of light-emitting indicators;
routing the wire along a route path marker on a routing surface of the formboard; and
inserting a second end of the wire into a second staging hole in the formboard associated with a second light-emitting indicator of the pair of light-emitting indicators.

18. The method of claim 16, further comprising displaying routing information corresponding to the wire on a graphical user interface.

19. The method of claim 16, further comprising:
receiving additional wire identifications corresponding to additional wires to be routed;
selectively activating pairs of light-emitting indicators on the formboard corresponding to the wire identifications;
placing the wires along wire route paths extending between the pairs of light-emitting indicators; and
securing the wires into a wire bundle.

20. The method of claim 19, further comprising:
verifying placement of the wires; and
displaying quality information corresponding to the wire bundle on a graphical user interface.
